(19) United States
(12) Patent Application Publication
(10) Pub. No.: US 2006/0236670 A1
(43) Pub. Date: Oct. 26, 2006

(54) Front mounted dethatcher unit for power mower

(76) Inventors: James Michael Glasford, Crooks, SD (US); Dale D. Devish, Sioux Falls, SD (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/398,492

(22) Filed: Apr. 5, 2006

Related U.S. Application Data
(60) Provisional application No. 60/668,566, filed on Apr. 5, 2005.

(51) Int. Cl. A01D 34/30; A01D 34/02

(52) U.S. Cl. 56/257

(57) ABSTRACT

The present invention comprises a dethatching device to be pushed ahead of a zero radius turn riding lawn mower. The dethatcher is operably coupled to a mower and comprises one or more wheels, one or more rows of tines, a lift handle, and a quick-disconnect. The one or more wheels include a height adjustment, and are disposed forward of the one or more rows of tines. The one or more rows of tines include a plurality of downwardly inclined tines configured to engage the topsoil of the ground. The lift handle is configured to raise the one or more wheels and the one or more rows of tines off of the ground. A retention member is provided for retaining the lift handle such that the wheels and the one or more rows of tines are in an elevated position. The quick-disconnect allows for a portion of the dethatcher to be de-coupled from the mower.

### RELATED APPLICATION

The present application claims the benefit of U.S. Provisional Application 30/668,566, filed Apr. 5, 2005 included herein in its entirety by reference.

### FIELD OF THE INVENTION

The present invention relates generally to a dethatcher unit for use with grass-cutting equipment. More specifically, the invention relates specifically to a front mounted dethatcher unit for a zero turning radius mower.

### BACKGROUND OF THE INVENTION

Over time, lawns can accumulate a layer of thatch. Thatch is an interwoven layer of dead leaves, roots, and other plant material that builds up under the grass. While a thin layer of thatch on a lawn is acceptable, a thick layer is not, as it suppresses growth of grass, prevents water from penetrating the soil, and provides an environment for fungus growth. Dethatching is commonly performed either with a hand rake, or with a power dethatcher.

Many devices have been devised in an effort to remove thatch from a lawn surface. One of the most common ways is with the use of a hand-held rake. The rake tines are drawn across the ground surface, dislodging thatch and plant matter. This method of removing thatch is very time-consuming, and also strenuous for the worker performing the dethatching. After dethatching with this method, the thatch must be collected and removed from the lawn surface.

Motorized dethatchers were developed to improve upon the hand raking method of removing thatch. Such motorized dethatchers often comprise a rotating shaft with a plurality of blades or tines disposed thereon, and are pulled behind a tractor or other power mover. However, such a device does not collect the thatch, and can also be expensive.

Other dethatchers include stationary tines disposed on a framework, and located in front of or behind a power mover such as a tractor. A typical arrangement includes downwardly projected and forwardly inclined tines. The tines are dragged across the lawn surface as the tractor moves forward.

Unfortunately, the prior dethatching solutions all suffer drawbacks, in that they are ineffective, too expensive, too cumbersome, or too complicated.

### SUMMARY OF THE INVENTION

The present invention comprises a dethatching device to be pushed ahead of a mower, preferably a zero radius turn riding lawn mower. The dethatcher is operably coupled to a mower and comprises one or more wheels, one or more rows of tines, a lift handle, and a quick-disconnect. The one or more wheels include a height adjustment, and are disposed forward of the one or more rows of tines. The one or more rows of tines include a plurality of downwardly inclined tines configured to engage the topsoil of the ground. The lift handle is configured to raise the one or more wheels and the one or more rows of tines off of the ground. A retention member is provided for retaining the lift handle such that the wheels and the one or more rows of tines are in an elevated position. The quick-disconnect allows for a portion of the dethatcher to be de-coupled from the mower.

It is an advantage of the present invention that a lawn can be dethatched, mowed, and the clippings bagged all at once.

It is a further advantage of the present invention that the dethatching unit is quickly and easily detachable from a mower.

It is a still further advantage of the present invention that the dethatcher unit can be raised clear of the ground and retained in an elevated position.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of a dethatcher according to the invention, shown coupled to a zero turning radius mower.

FIG. 2 is a side perspective view of a dethatcher according to the invention.

FIG. 3 is a rear perspective view of a dethatcher according to the invention.

FIG. 4 is a rear perspective view of a dethatcher according to the invention tipped on its front end and having a mounting portion removed.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE DRAWINGS

In the following detailed description of the present invention, numerous specific details are set forth in order to provide a thorough understanding of the present invention. However, it will be obvious to one skilled in the art that the present invention may be practiced without these specific details. In other instances, well-known methods, procedures, and components have not been described in detail so as to not unnecessarily obscure aspects of the present invention.

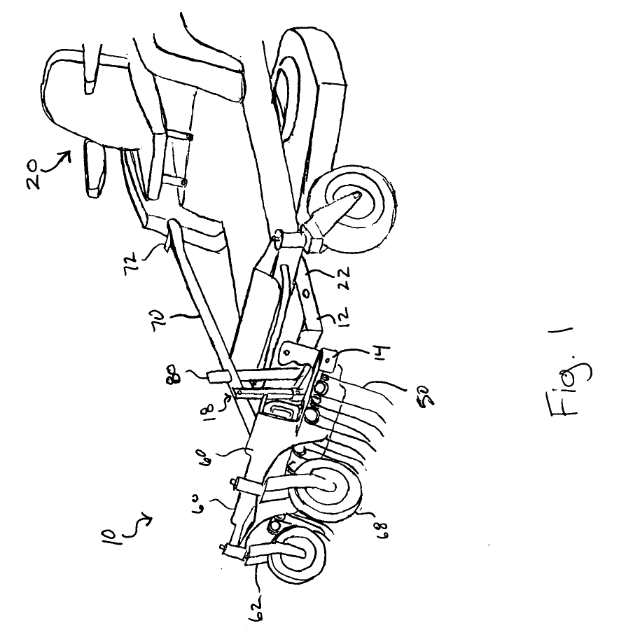

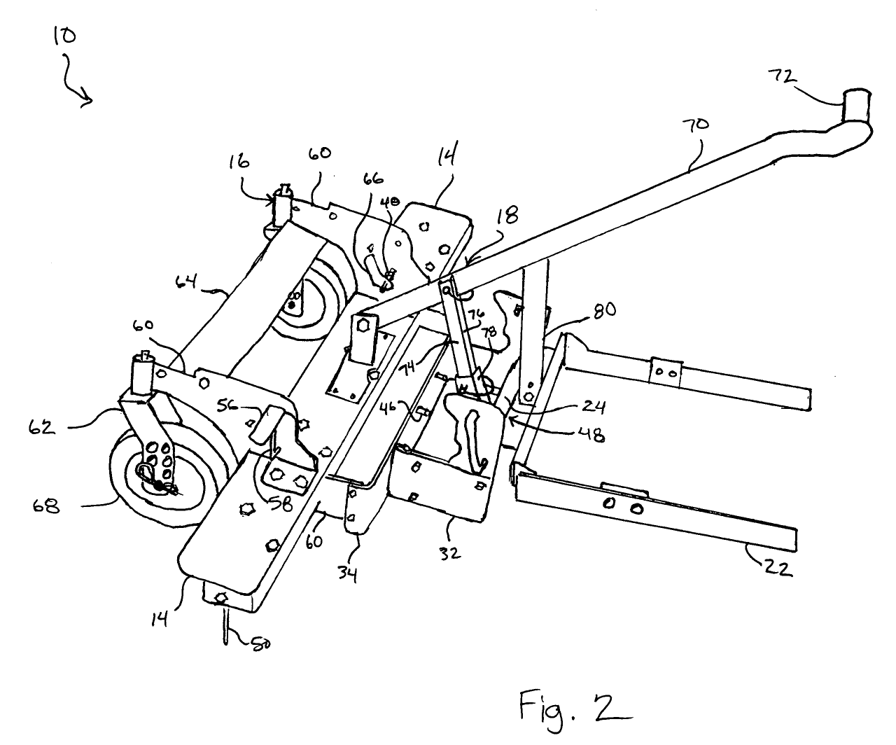

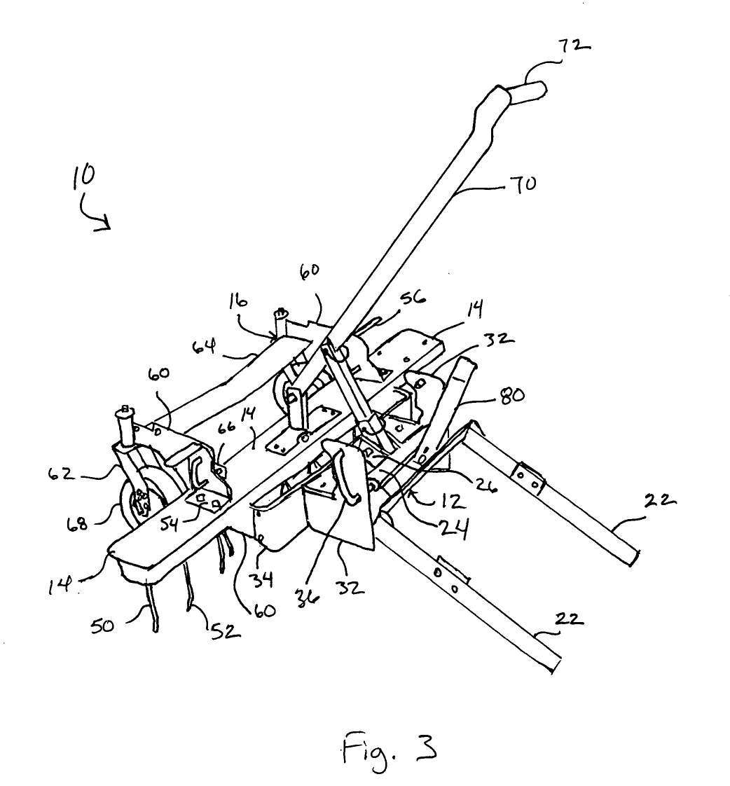

Referring now to FIGS. 1-4, a dethatcher 10 is provided for use with a lawn vehicle 20. In a preferred embodiment, lawn vehicle 20 comprises a riding lawn mower of the zero radius turn type, although dethatcher 10 may also be used with a conventional riding lawn mower or a suitably sized tractor. Dethatcher 10 comprises a mounting portion 12, a tine head 14, a wheel unit 16, and a lifting arrangement 18.

Mounting portion 12 is configured for coupling dethatcher 10 to mower 20. In a preferred embodiment, mounting portion 12 is removably coupled to mower 20, although mounting portion 12 may also be permanently coupled to mower 20. A pair of longitudinally-oriented arms 22 are provided for coupling to mower 20, and arms 22 may include structure such as holes for coupling mounting portion 12 to mower 20 with the use of fasteners such as bolts. Arms 22 can extend underneath the footrest area of a typical zero turning radius mower to couple to the frame of said mower, or arms 22 may be coupled to the front portion of the frame of a typical tractor. A hinge coupling 24 is provided for pivotably coupling mounting portion 12 to dethatcher 10. During the operation of lifting arrangement 18 (discussed in greater detail below), dethatcher 10 tilts vertically about hinge coupling 24 so as to pivot dethatcher 10 about a lateral axis, raising tine head 14 above the ground and allowing for transport of dethatcher 10 across hard surfaces or during mower turns. Hinge coupling 24 also allows for pivoting of dethatcher 10 in the vertical direction during use, such that while cresting hills or traversing dips, dethatcher 10 is maintained in contact with the ground. A bracket 26 is also provided on mounting portion 12 for receiving a portion of lifting arrangement 18.

A pivot joint 30 rotatably couples mounting portion 12 to tine head 14 and wheel unit 16. Pivot joint 30 comprises a first portion 32 coupled to mounting portion 12, and a second portion 34 coupled to a portion of wheel unit 16. In a preferred embodiment, first portion 32 includes two pins 36 adapted to engage with hinge coupling 24. Hinge coupling 24 may comprise an elongated cylindrical structure, adapted for receiving a pin 36 in either end. Pin guides 38 are provided for maintaining alignment of pin 36, and biasing members 40 are included to bias pins 36 in an engaged position with hinge coupling 24. Biasing members 40 may comprise springs disposed between pin guide 38 and first portion 32. Such an arrangement of biased pins 36 and hinge coupling 24 comprises a quick-change structure 48 for quickly and easily attaching or detaching dethatcher 10 from its mounting portion 12.

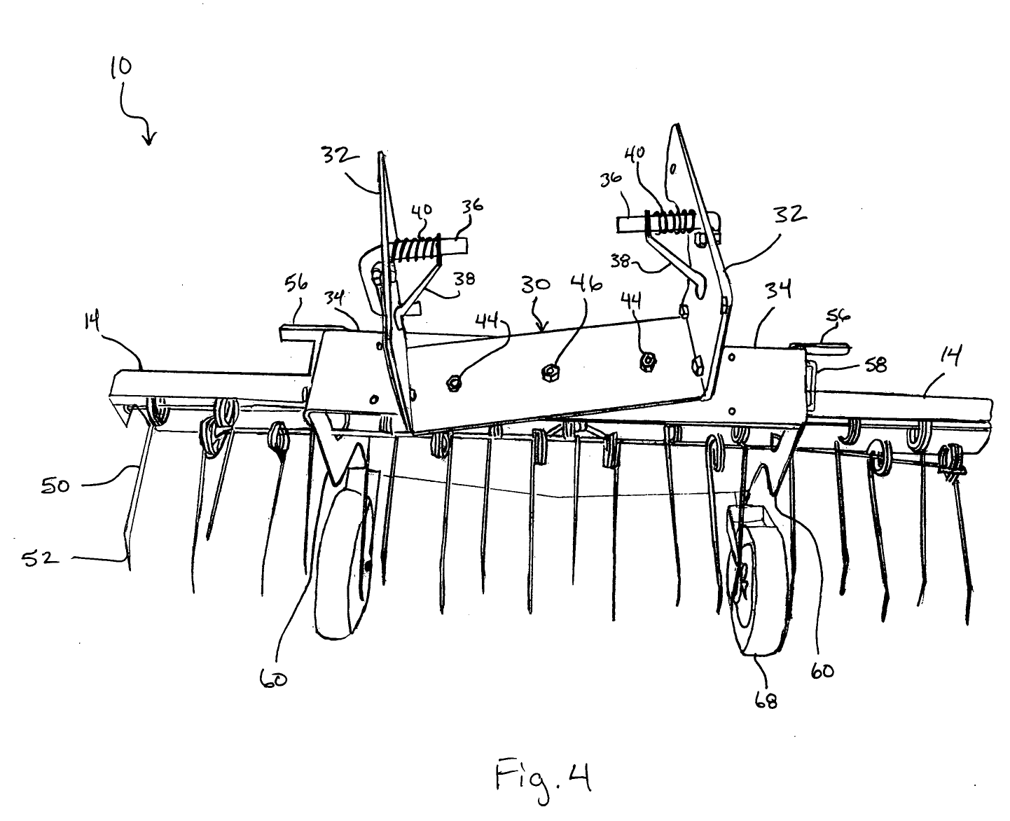

To decouple dethatcher 10 from mower 20 rather than removing mounting portion 12 from mower 20, pins 36 are retracted from hinge coupling 24 such that mounting portion 12 remains coupled to mower 20 while the remaining components of dethatcher 10 are detached and removed. Second portion 34 of pivot joint 30 includes structure allowing for pivoting (or rotation) between second portion 34 and first portion 32, such structure preferably comprising slots in second portion 34. Said rotation is about a longitudinal axis, such that when dethatcher 10 is being operated, an operator viewing said rotation will observe dethatcher 10 tilting either left or right. FIG. 4 best illustrates the rotation of pivot joint 30, wherein first portion 32 can be seen rotated counter-clockwise from second portion 34. Multiple fasteners 44 are provided for coupling first portion 32 and second portion 34, wherein a central fastener comprises a pivot point 46, and outer fasteners are permitted to travel within the slots in second portion 34. Exemplary fasteners 42 comprise bolts and nuts, although other suitable fasteners recognized by those skilled in the art are similarly acceptable. The pivoting action between first portion 32 and second portion 34 is beneficial while traversing uneven surfaces, helping to maintain dethatcher 10 in contact with the ground.

Tine head 14 retains a plurality of tines 50. Tines 50 may be arranged in one row or multiple rows, depending on the desired application. Each tine 50 in each row is preferably offset from each tine 50 in other rows so as to maximize dethatching effectiveness. Each tine 50 is biased forward into the direction of travel. Tines 50 are downwardly directed and may include on the distal end a tip portion 52 angled further forward. Tines 50 are adapted to engage the ground during operation of dethatcher 10 and loosen and remove thatch on the ground. Each tine 50 may also include on the proximate end a coiled portion for biasing tine 50 forward. The coiled portion of tine 50 may provide structure for coupling tine 50 to tine head 14. Tine head 14 further includes structure for coupling to wheel unit 16, such as brackets 54. Brackets 54 may include a handle portion 56 for lifting dethatcher 10 during servicing or transport. A pin or bolt 58 is disposed through each bracket 54 and engaged with wheel unit 16.

Wheel unit 16 includes two mounting plates 60, each mounting plate 60 having a first end extended underneath tine head 14 and coupled to second portion 34 of pivot joint 30, and a second end coupled to wheel carrier 62. A brace 64 is coupled between each mounting plate 60, providing structural integrity. Plate 60 may be coupled to bracket 54 of tine head 14 with a fastener 58 such as bolts, pins, or the like. If a pin is to be used, plate 60 can include a pin guide 66 configured to receive pin 58. Wheel carrier 62 is rotatably coupled to mounting plate 60 and wheel carrier 62 includes structure for multiple mounting locations of a wheel 68. In a preferred embodiment, wheel 68 is coupled to wheel carrier 62 with a pin or bolt, and wheel carrier 62 includes a plurality of holes at different heights for mounting wheel 68 such that wheel 68 is selectively engageable between the plurality of holes. By relocating wheel 68 to different mounting holes, an operator can vary the height of dethatcher 10 and thereby vary the depth of engagement of tines 50. Preferably, wheel 68 is located forward of tine head 14. In an alternate embodiment of dethatcher 10, mounting plates 60 are coupled to the top of tine head 14, and tine head 14 is coupled directly to second portion 34 of pivot joint 30. In a still further embodiment, wheel unit 16 comprises a rollable member, such as a cylindrical drum, located forward of tine head 14. Said cylindrical drum may be constructed of metal or a polymer such as nylon, delrin, or other similar suitable polymers.

While using dethatcher 10 it may become necessary to temporarily raise tines 50 above the ground, for example while crossing a driveway, road, or any surface not desired to be dethatched. In a preferred embodiment, a lifting arrangement 18 comprises a lift arm 70 having a handle portion 72, and a linkage 74. Linkage 74 comprises a first portion 76 engageably and releasably coupled to a second portion 78. Lift arm 70 is coupled to tine head 14, wherein tine head 14 may include a bracket for such purposes. First portion 76 of linkage 74 is coupled to lift arm 70, and second portion 78 of linkage 74 is coupled to bracket 26 on mounting portion 12. Lift arm 70 may include multiple locations for receiving first portion 76 of linkage 74. Further, first portion 76 and second portion 78 may each have multiple coupling locations, such that the selection of different coupling locations varies the overall length of linkage 74 and therefore the mechanical advantage of lifting arrangement 18.

If an operator of dethatcher 10 wishes to raise tine head 14 and wheel unit 16 off of the ground, he or she simply pulls down on lift arm 70. To maintain tine head 14 and wheel unit 16 in an elevated position above the ground as shown in FIG. 1, lifting arrangement 18 may include a retainer 80. Retainer 80 is configured to hold lift arm 70 such that tine head 14 is not in contact with the ground, allowing travel over driveways, roads, or the like. Retainer 80 may comprise a top portion having a hooked shape to retain lift arm 70, or retainer 80 may be configured to utilize a fastener for releasably coupling to lift arm 70. Retainer 80 is coupled to mounting portion 12, and it may be desirable to couple retainer 80 in an easily releasable manner. When it is desired to detach part of dethatcher 10, leaving mounting portion 12 coupled to mower 20, it may be desirable to remove retainer 80 so as to not be in the way for an operator of mower 20.

In an alternate embodiment of lifting arrangement 18, tine head 14 may be raised above the ground while wheel unit 16 maintains contact with the ground. In such an arrangement, each mounting plate 60 is provided with multiple locations for receiving pin 58. With pin 58 engaged in a first location on plate 60, tine head 14 is maintained in its normal operating position. Each pin 58 may be removed, and tine head 14 swiveled up such that tines 50 are no longer in contact with the ground, and pin 58 is then engaged in an alternate location that maintains tine head 14 in a non-contact position. Handle portion 56 on bracket 54 may be helpful in assisting an operator move tine head 14 into a non-contact position with the ground.

To easily disconnect dethatcher 10 from mower 20, dethatcher 10 must be in the down position, such that tines 50 are in contact with the ground. A user first decouples lifting arrangement 18, which may be done by decoupling linkage 74 from lift arm 70, or by decoupling first portion 76 from second portion 78. Then a user pulls out pin 36 from either side of first portion 32 of pivot joint 30. Once both pins 36 are disengaged from hinge coupling 24, the remainder of dethatcher 10 (second portion 34, tine head 14, wheel unit 16, and lift arrangement 18) can be moved away from mower 20.

To operate dethatcher 10 with a mower 20, an operator of mower 10 ensures dethatcher 10 is lowered to the ground such that tines 50 are in contact with the ground. In a preferred embodiment, tines 50 are configured so as to rest on the ground while dethatcher 10 is at rest, such that tines 50 support the weight of dethatcher 10. As mower 20 advances forward, pushing dethatcher 10 with it, tines 50 are deflected slightly rearwardly and downwardly, allowing tip portion 52 to tear up and dislodge thatch contained on the ground. The rearward deflection of tines 50 slightly lowers tine head 14, allowing wheel 68 to contact the ground and roll as dethatcher 10 is pushed forward. Loose thatch material on the ground is then easily collected with the vacuum created by the rotation of the blades on mower 20. Mower 20 may optionally be equipped with a collection arrangement to collect and bag clipped grass and thatch.

When making a turn while mower 20 is stopped (a zero radius turn), dethatcher 10 may be raised above the ground with lifting arrangement 18, or left in contact with the ground.

Although one embodiment of mounting portion 12 is illustrated in the Figures, mounting portion 12 may be varied so as to be suitable for use with a variety of mowers or tractors. For instance, arms 22 may comprise flat stock steel, square stock steel, tubular steel, or other suitable materials such as alloys, aluminum, extruded aluminum, or composites, and arms 22 may be formed into a u-shape having arms extending toward the mower, or a reverse u-shape having arms extending toward hinge coupling 24. Alternatively, mounting portion 12 may include laterally-oriented structure suitable for coupling dethatcher 10 to mower 20. Mounting portion 12 may further comprise multiple hinge couplings 24, for example two hinge couplings aligned on a common axis. It will be apparent to one skilled in the art that when coupling dethatcher 10 to mower 20, mounting portion 12 must be configured so as to not interfere with the cutting blades of mower 20.

It is contemplated that a quick-change mounting arrangement according to the present invention may be used with implements other than a dethatcher for attaching to mowers, tractors, or the like. Common small implements such as plows, seeders, spreaders, fertilizer units, tillers, cultivators, or brooms may be coupled to either hinge coupling 24, or second portion 34 of pivot joint 30. Lifting arrangement 18 may also be adaptable for use with many implements.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives. For example, it is contemplated that where two or more components are joined or coupled together, the joint may be removable, releasable, pivotable, or a combination thereof. Unless specified otherwise, it should be appreciated that bolts and nuts, screws, pins, quick-release pins, or other such fasteners may be used to accomplish the coupling of two or more components.

What is claimed is:

1. A readily detachable, pushable dethatcher for use with a self-propelled vehicle, comprising:
a plurality of downwardly directed and forwardly biased tines for loosening thatch on the ground, the plurality of tines being in a contact position with the ground;
a wheel located forward of the plurality of tines;
a lifting apparatus adapted to raise the plurality of tines into a transport position; and
a mounting portion coupled to the vehicle and adapted to pivotably couple the dethatcher to the vehicle, wherein the dethatcher is moveable between the contact position and the transport position.

2. The dethatcher of claim 1, the mounting portion further comprising a quick-release, adapted to detach and attach the dethatcher from the mower at the mounting portion.

3. The dethatcher of claim 1, further comprising a pivot joint adapted to allow pivoting of the dethatcher about a longitudinal axis.

4. The dethatcher of claim 1 further comprising a height adjustment, the wheel being coupled to the height adjustment and selectively engageable between multiple heights.

5. The dethatcher of claim 1 further comprising a retainer for retaining the lifting apparatus such that plurality of tines is held in the transport position.

6. The dethatcher of claim 1, wherein the mounting portion comprises a pair of arms coupled to the vehicle.

7. A mount for mounting an implement to a powered vehicle, comprising:
a mounting portion coupled to the vehicle and adapted to pivotably couple the implement to the vehicle, wherein the implement is moveable between an implement engaged operating position and a disengaged transport position; and
a quick-release, adapted to detach and attach the implement from the vehicle at the mounting portion.

8. The mount of claim 7, further comprising a pivot joint adapted to allow pivoting of the implement about a longitudinal, fore-aft axis.

9. The mount of claim 7, further comprising a pivot joint adapted to allow pivoting of the implement about a transverse side-side axis.

10. The mount of claim 7, including a pivot joint having a first portion coupled to a vehicle mounting portion and a second portion coupled to a portion of the implement.

11. The mount of claim 10 wherein the first portion includes a plurality of pins, each pin of the plurality of pins being adapted to engage with a hinge coupling.

12. The mount of claim 11, the hinge coupling may being an elongated cylindrical structure having first and second opposed ends and being adapted for receiving a pin 3 in either end.

13. The mount of claim 12 wherein in a respective pin guide are provided for each of the pins of the plurality of pins and a respective biasing member included for each pin for biasing the respective pins in an engaged disposition with the hinge coupling.

14. A method of forming a readily detachable, pushable dethatcher for use with a self-propelled vehicle, comprising:
forwardly biasing a plurality of downwardly directed tines for loosening thatch;
disposing the plurality of tines being in an operating contact position with the ground;
locating at least one wheel forward of the plurality of tines;
selectively raising the plurality of tines into a transport position by means of a lifting apparatus; and
pivotably coupling the dethatcher to the vehicle.

15. The method of claim 14, including detaching and attaching the dethatcher from the vehicle by means of a quick-release coupler.

16. The method of claim 14, including pivoting of the dethatcher about a longitudinal axis by means of a pivot joint.

17. The method of claim 14 including varying the height of the dethatcher by means of the wheel being coupled to the height adjustment and being selectively engageable between multiple heights.

18. The method of claim 14 including retaining the lifting apparatus in an elevated disposition such that plurality of tines is held in the transport position.

19. The method of claim 14, inclingde mounting the dethatcher to the vehicle by means a pair of arms coupled to the vehicle.
